(19) United States
(12) Patent Application Publication
(10) Pub. No.: US 2022/0201548 A1
(43) Pub. Date: Jun. 23, 2022

(54) METHOD AND USER EQUIPMENT FOR OPTIMIZING MOBILE NETWORK CONGESTION

(71) Applicant: MediaTek Singapore Pte. Ltd., Singapore (SG)

(72) Inventor: Junpeng WANG, Shanghai (CN)

(21) Appl. No.: 17/537,711

(22) Filed: Nov. 30, 2021

(30) Foreign Application Priority Data
Dec. 21, 2020 (CN) 202011519743.1
Nov. 9, 2021 (CN) 202111322250.3

(51) Int. Cl. H04W 28/02; H04W 36/22; H04W 48/06

(52) U.S. Cl. CPC H04W 28/0289; H04W 48/06; H04W 36/22

(57) ABSTRACT

A method for optimizing mobile network congestion includes detecting that the UE is in a congestion mode; determining whether the UE enters the RRC connection mode in a first priority cell; determining whether shortening at least one timer of the UE is able to improve the mobile network congestion if the UE does not enter the RRC connection mode; determining whether reporting the larger data size of the BSR to the mobile network is able to improve the mobile network congestion if the UE enters the RRC connection mode; reselecting a second priority cell if shortening the at least one timer of the UE is not able to improve the mobile network congestion; and handing over to the second priority cell if reporting the larger data size of the BSR to the mobile network is not able to improve the mobile network congestion.

### CROSS REFERENCE TO RELATED APPLICATIONS

This application claims priority of and the benefit of China Application No. 202011519743.1, filed on Dec. 21, 2020 and China Application No. 202111322250.3 filed on Nov. 9, 2021, the entirety of which are incorporated by reference herein.

### FIELD OF THE DISCLOSURE

The present invention is related to mobile communications, and in particular it is related to a method and a UE for optimizing mobile network congestion.

### DESCRIPTION OF THE RELATED ART

At crowded events such as football games and music concerts, network resources soon become insufficient since many mobile terminals are all trying to gain access to the same cell, which causes the mobiles terminals to start call/internet browser failed or the lower speed to access. Therefore, detecting network congestion from system information broadcast by a network or from messages between the mobile phone and the network, and further alleviating the congestion, have become important subjects.

### BRIEF SUMMARY OF THE DISCLOSURE

In order to resolve the issue described above, the present invention provides a method for optimizing congestion in a mobile network. The method includes: detecting that user equipment (UE) is in a congestion mode; determining whether the UE enters the Radio Resource Control (RRC) connection mode in a first priority cell; determining whether shortening at least one timer of the UE is able to improve the congestion of the mobile network if the UE does not enter the RRC connection mode; determining whether reporting the larger data size of the buffer status report (BSR) to the mobile network is able to improve the congestion of the mobile network if the UE enters the RRC connection mode; reselecting a second priority cell if shortening the at least one timer of the UE is not able to improve the congestion of the mobile network; and handing over to the second priority cell if reporting the larger data size of the BSR to the mobile network is not able to improve the congestion of the mobile network.

According to the method above, the step of detecting that the UE is in the congestion mode includes: detecting that the number of access rejections from the mobile network for RRC connection is more than a first threshold within a first period of time; detecting that the number of access class (AC) barring from the mobile network is more than a second threshold within a second period of time; detecting that the number of consecutive preambles send for success random-access channel (RACH) procedure is more than a third threshold when the first priority cell has good signal power; detecting that a first back-off timer is present in a random access response (RAR) message from the mobile network; and/or detecting that the resources provided by the mobile network to the UE is less than what the UE requests within a third period of time when the first priority cell has good signal power.

According to the method above, the step of detecting that the UE is in the congestion mode further includes: detecting that the cause value of access rejections from the mobile network for ATTACH/TAU/EMM services is “congestion”; and detecting that a second back-off timer is present in the access rejections from the mobile network for ATTACH/TAU/EMM services.

According to the method above, the first threshold, the second threshold, the third threshold, the first period of time, the second period of time, the third period of time can be set in the timer of the UE. The first back-off timer is included in the RAR message and the second back-off timer is included in the ATTACH/TAU/EMM REJECT message.

According to the method above, the step of detecting that the resources provided by the mobile network to the UE is less than what the UE requests within the third period of time when the first priority cell has good signal power includes: detecting that the data size of granted upload data of the UE is smaller than that of the BSR multiplying a predetermined percentage within the third period of time when the first priority cell has good signal power.

According to the method above, the method further includes: determining that the congestion of the mobile network is alleviated if shortening the timer of the UE is able to improve the congestion of the mobile network; and determining that the congestion of the mobile network is alleviated if reporting the larger data size of the BSR to the mobile network is able to improve the congestion of the mobile network.

The present invention also provides user equipment including an application processor and a modem. The application processor is configured to implement the following tasks: detecting that the UE is in a congestion mode; determining whether the UE enters the RRC connection mode in a first priority cell; determining whether shortening at least one timer of the UE is able to improve the congestion of the mobile network if the UE does not enter the RRC connection mode; and determining whether reporting the larger data size of a BSR to the mobile network is able to improve the congestion of the mobile network if the UE enters the RRC connection mode. The modem is configured to implement the following tasks: reselecting a second priority cell if shortening the timer of the UE is not able to improve the congestion of the mobile network; and handing over to the second priority cell if reporting the larger data size of the BSR to the mobile network is not able to improve the congestion of the mobile network.

According to the UE above, the application processor detects that the UE is in the congestion mode according to the following tasks performed by the modem, comprising: detecting that the number of access rejections from the mobile network for RRC connection is more than a first threshold within a first period of time; detecting that the number of AC barring from the mobile network is more than a second threshold within a second period of time; detecting that the number of consecutive preambles send for success RACH procedure is more than a third threshold when the first priority cell has good signal power; detecting that a first back-off timer is present in a RAR message from the mobile network; and/or detecting that the resources provided by the mobile network to the UE is less than what the UE requests within a third period of time when the first priority cell has good signal power.

According to the UE above, the application processor detects that the UE is in the congestion mode according to the following tasks performed by the modem, further comprising: detecting that the cause value of access rejections from the mobile network for ATTACH/TAU/EMM services is “congestion”; and detecting that a second back-off timer is present in the access rejections from the mobile network for ATTACH/TAU/EMM services.

According to the UE above, the first threshold, the second threshold, the third threshold, the first period of time, the second period of time, the third period of time can be set in the timer of the UE. The first back-off timer is included in the RAR message and the second back-off timer is included in the message of ATTACH/TAU/EMM REJECT message.

According to the UE above, the modem detects that the resources provided by the mobile network to the UE is less than what the UE requests within the third period of time when the first priority cell has good signal power. This comprises the modem detecting that the data size of granted upload data of the UE is smaller than that of the BSR multiplied by a predetermined percentage within the third period of time when the first priority cell has good signal power.

According to the UE above, the application processor further implements the following tasks: determining that the congestion of the mobile network is alleviated if shortening the timer of the UE is able to improve the congestion of the mobile network; and determining that the congestion of the mobile network is alleviated if reporting the larger data size of the BSR to the mobile network is able to improve the congestion of the mobile network.

### BRIEF DESCRIPTION OF THE DRAWINGS

The disclosure can be more fully understood by reading the subsequent detailed description with references made to the accompanying figures. It should be understood that the figures are not drawn to scale in accordance with standard practice in the industry. In fact, it is allowed to arbitrarily enlarge or reduce the size of components for clear illustration. This means that many special details, relationships and methods are disclosed to provide a complete understanding of the disclosure.

FIG. 1 is a flow chart of a method for optimizing congestion of a mobile network in accordance with some embodiments of the present invention.

FIG. 2 is a flow chart of a method for determining whether the 1st congestion condition is met or not in accordance with some embodiments of the present invention.

FIG. 3 is a flow chart of a method for determining whether the 2nd congestion condition is met or not in accordance with some embodiments of the present invention.

FIG. 4 is a flow chart of a method for determining whether the 3rd congestion condition is met or not in accordance with some embodiments of the present invention.

FIG. 5 is a flow chart of a method for determining whether the 4th congestion condition is met or not in accordance with some embodiments of the present invention.

FIG. 6 is a flow chart of a method for determining whether the 5th congestion condition is met or not in accordance with some embodiments of the present invention.

FIG. 7 is a flow chart of a method for determining whether the 6th congestion condition is met or not in accordance with some embodiments of the present invention.

FIG. 8 is a schematic diagram of a user equipment in accordance with some embodiments of the present invention.

### DETAILED DESCRIPTION OF THE DISCLOSURE

Certain words are used to refer to specific elements in the specification and the claims. Those with ordinary knowledge in the technical field should understand that hardware manufacturers may use different terms to refer to the same component. The specification and the claims of the present invention do not use differences in names as a way to distinguish elements, but use differences in functions of elements as a criterion for distinguishing. The “comprise” and “include” mentioned in the entire specification and the claims are open-ended terms, so they should be interpreted as “including but not limited to”. “Generally” means that within an acceptable error range, a person with ordinary knowledge in the technical field can solve the technical problem within a certain error range, and basically achieve the technical effect. In addition, the term “coupled” herein includes any direct and indirect electrical connection means. Therefore, if it is described in the text that a first device is coupled to a second device, it means that the first device can be directly electrically connected to the second device, or indirectly electrically connected to the second device through other devices or connecting means.

The following description is the best embodiment expected of the present invention. These descriptions are used to illustrate the general principles of the present invention and should not be used to limit the present invention. The protection scope of the present invention should be determined on the basis of referring to the scope of the claims of the present invention.

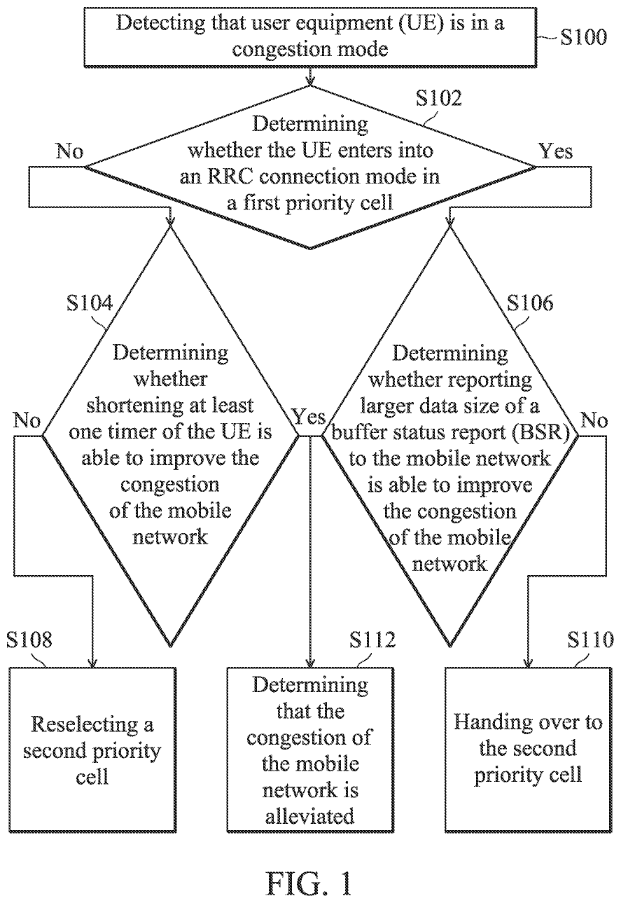

FIG. 1 is a flow chart of a method for optimizing congestion of a mobile network in accordance with some embodiments of the present invention. As shown in FIG. 1, the method for optimizing congestion of the mobile network includes: detecting that user equipment (UE) is in a congestion mode (step S100); determining whether the UE enters the RRC connection mode in a first priority cell (step S102); determining whether shortening at least one timer of the UE is able to improve the congestion of the mobile network if the UE does not enter the RRC connection mode (step S104); determining whether reporting the larger data size of the buffer status report (BSR) to the mobile network is able to improve the congestion of the mobile network if the UE enters the RRC connection mode (step S106); reselecting a second priority cell if shortening the timer of the UE is not able to improve the congestion of the mobile network (step S108); and handing over to the second priority cell if reporting the larger data size of the BSR to the mobile network is not able to improve the congestion of the mobile network (step S110).

In step S100, the method for optimizing congestion of the mobile network of the present invention detects whether the UE is in the congestion mode due to six congestion conditions. If at least one of the six congestion conditions is met, the method of the present invention determines that the UE is in the congestion mode. The six congestion conditions include: detecting that the number of access rejections from the mobile network for RRC connection is more than a first threshold within a first period of time (1st congestion condition); detecting that the number of access class (AC) barring from the mobile network is more than a second threshold within a second period of time (2nd congestion condition); detecting that the cause value of access rejections from the mobile network for ATTACH/TAU/EMM services is “congestion”; and detecting that a back-off timer is present in the access rejections from the mobile network for ATTACH/TAU/EMM services (3rd congestion condition); detecting that the number of consecutive preambles send for success random-access channel (RACH) procedure is more than a third threshold when the first priority cell has good signal power (4th congestion condition); detecting that a back-off timer is present in a random access response (RAR) message from the mobile network (5th congestion condition); and/or detecting that the resources provided by the mobile network to the UE is less than what the UE requests within a third period of time when the first priority cell has good signal power (6th congestion condition).

In step S102, the method of the present invention determines whether the UE enters the RRC connection mode in the first priority cell. If no, the method of the present invention approaches to the step S104. In contrary, if yes, the method of the present invention approaches to the step S106. In some embodiments, if the UE has not entered the RRC connection mode yet, then the UE is still in an idle mode. The timer of the UE can be adjusted when the UE is in the idle mode. Therefore, in some embodiments, 1st congestion condition, 2nd congestion condition, 4th congestion condition, and 5th congestion condition can be met only when the UE is in the idle mode. In some embodiments, 3rd congestion condition and 6th congestion condition can be met only when the UE is in the RRC connection mode.

In step S104, the method of the present invention determines whether shortening at least one timer of the UE is able to improve the congestion of the mobile network if the UE does not enter the RRC connection mode. If no, the method of the present invention approaches to step S108. If yes, the method of the present invention approaches to step S112. In some embodiments, if the method of the present invention detects that the UE is in the congestion mode due to 1st congestion condition, 2nd congestion condition, 4th congestion condition, and/or 5th congestion condition, then step S104 may be approached. In step S108, since most UEs camp on the first priority cell, the method of the present invention reselects a second priority cell if shortening the timer of the UE is not able to improve the congestion of the mobile network. In step S112, the method of the present invention determines that the congestion of the mobile network is alleviated if shortening the timer of the UE is able to improve the congestion of the mobile network.

In step S106, the method of the present invention determines whether reporting the larger data size of the buffer status report (BSR) to the mobile network is able to improve the congestion of the mobile network if the UE enters the RRC connection mode. If no, the method of the present invention approaches to step S110. If yes, the method of the present invention approaches to step S112. In some embodiments, if the method of the present invention detects that the UE is in the congestion mode due to 3rd congestion condition and/or 6th congestion condition, then step S106 may be approached. In step S110, since most UEs camp on the first priority cell, the method of the present invention hands over to the second priority cell if reporting the larger data size of the BSR to the mobile network is not able to improve the congestion of the mobile network. In step S112, the method of the present invention determines that the congestion of the mobile network is alleviated if reporting the larger data size of the BSR to the mobile network is able to improve the congestion of the mobile network.

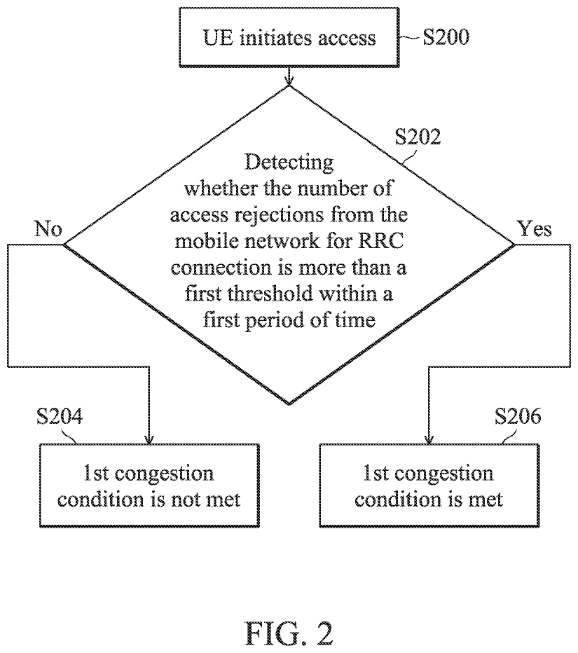

FIG. 2 is a flow chart of a method for determining whether the 1st congestion condition is met or not in accordance with some embodiments of the present invention. As shown in FIG. 2, in step S200, the UE initiates access to the mobile network. In step S202, the method for determining whether the 1st congestion condition is met or not detects whether the number of access rejections from the mobile network for RRC connection is more than a first threshold within a first period of time. If yes, 1st congestion condition is met in step S206. If no, 1st congestion condition is not met in step S204. In some embodiments, if 1st congestion condition is met, the method for optimizing congestion of the mobile network of present invention reduces a T302 timer of the UE in 3GPP specification.

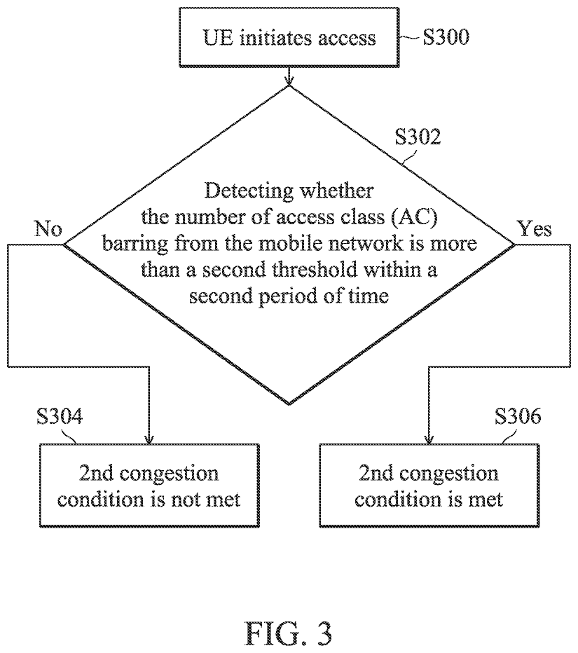

FIG. 3 is a flow chart of a method for determining whether the 2nd congestion condition is met or not in accordance with some embodiments of the present invention. As shown in FIG. 3, in step S300, the UE initiates access to the mobile network. In step S302, the method for determining whether the 2nd congestion condition is met or not detects whether the number of access class (AC) barring from the mobile network is more than a second threshold within a second period of time. If yes, 2nd congestion condition is met in step S306. If no, 2nd congestion condition is not met in step S304. In some embodiments, if 2nd congestion condition is met, the method for optimizing congestion of the mobile network of present invention reduces a T303 timer, a T305 timer and a T306 timer of the UE in 3GPP specification.

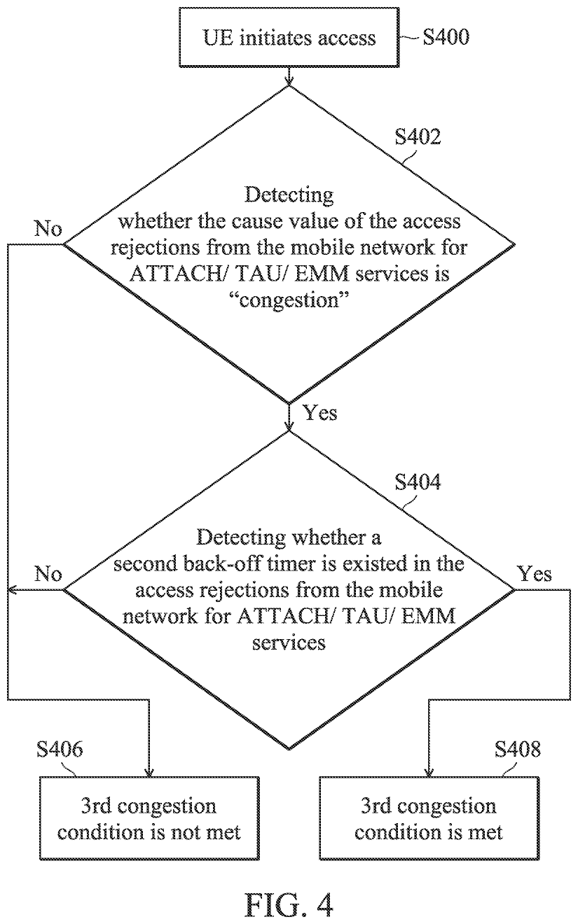

FIG. 4 is a flow chart of a method for determining whether the 3rd congestion condition is met or not in accordance with some embodiments of the present invention. As shown in FIG. 4, in step S400, the UE initiates access to the mobile network. In step S402, the method for determining whether the 3rd congestion condition is met or not detects whether the cause value of access rejections from the mobile network for ATTACH/TAU/EMM services is “congestion”. If yes, the method for determining whether the 3rd congestion condition is met or not approaches to step S404. If no, 3^{rd} congestion condition is not met in step S406. In some embodiments, ATTACH service is used for registration with the mobile network. TAU service is used for updating tracking area information. EMM service is used for requesting the RRC connection with the mobile network.

In step S404, the method for determining whether the 3rd congestion condition is met or not further detects whether a back-off timer is present in the access rejections from the mobile network for ATTACH/TAU/EMM services. If yes, 3rd congestion condition is met in step S408. If no, 3rd congestion condition is not met in step S406. In some embodiments, if 3rd congestion condition is met, the method for optimizing congestion of the mobile network of present invention reduces a T3346 timer of the UE in 3GPP specification.

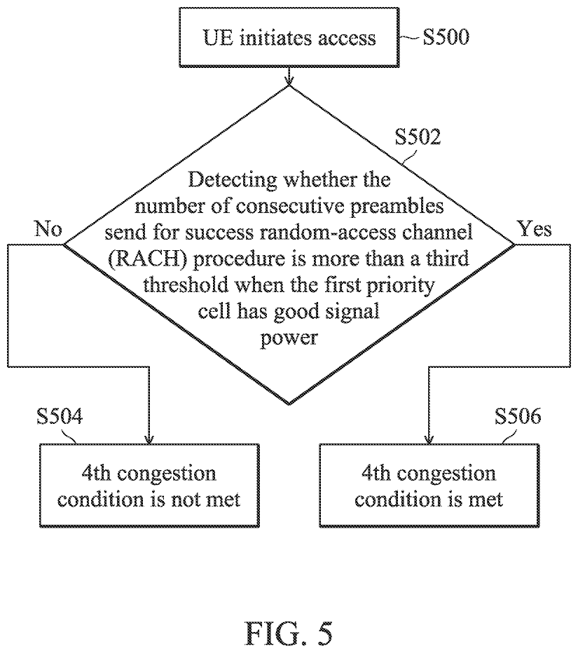

FIG. 5 is a flow chart of a method for determining whether the 4th congestion condition is met or not in accordance with some embodiments of the present invention. As shown in FIG. 5, in step S500, the UE initiates access to the mobile network. In step S502, the method for determining whether the 4th congestion condition is met or not detects whether the number of consecutive preambles send for success random-access channel (RACH) procedure is more than a third threshold when the first priority cell has good signal power. If yes, 4th congestion condition is met in step S506. If no, 4th congestion condition is not met in step S504. In some embodiments, if the mobile network does not reply on the consecutive preamble send by the UE for success RACH procedure even the first priority cell has good signal power, it means that the mobile network suffers congestion, so that 4th congestion condition is met.

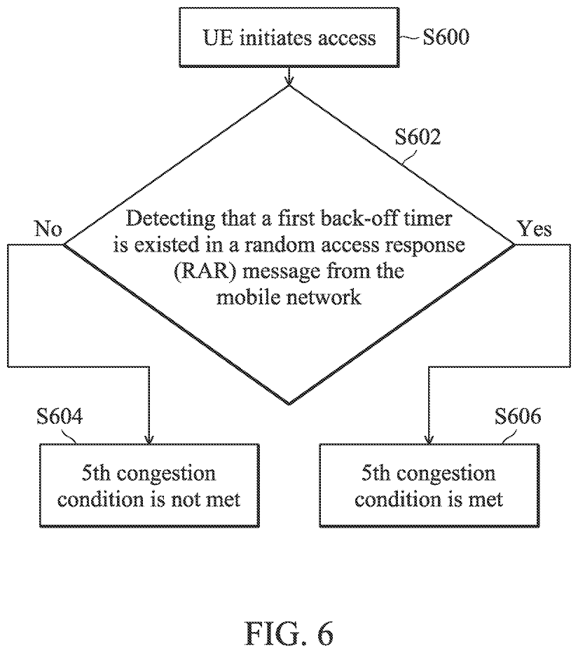

FIG. 6 is a flow chart of a method for determining whether the 5th congestion condition is met or not in accordance with some embodiments of the present invention. As shown in FIG. 6, in step S600, the UE initiates access to the mobile network. In step S602, the method for determining whether the 5th congestion condition is met or not detects whether a back-off timer is present in a random access response (RAR) message from the mobile network. If yes, 5th congestion condition is met in step S606. If no, 5th congestion condition is not met in step S604. In some embodiments, if 5th congestion condition is met, the method for optimizing congestion of the mobile network of present invention reduces the back-off timer of the UE for RACH and increases the TX power of subsequent preambles.

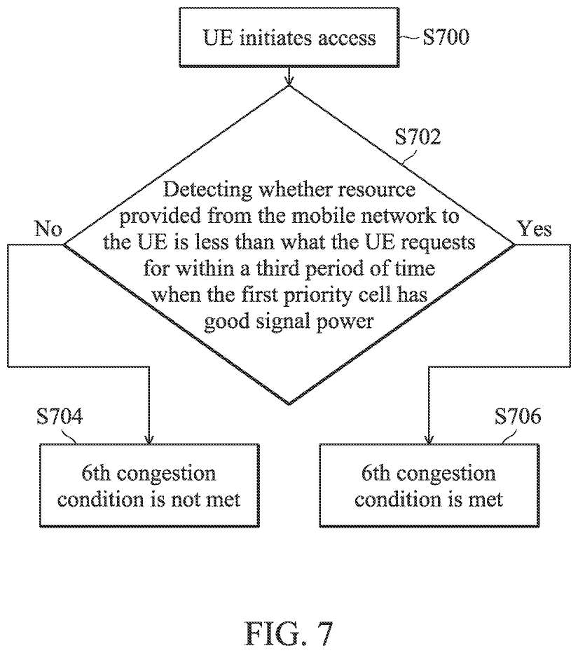

FIG. 7 is a flow chart of a method for determining whether the 6th congestion condition is met or not in accordance with some embodiments of the present invention. As shown in FIG. 7, in step S700, the UE initiates access to the mobile network. In step S702, the method for determining whether the 6th congestion condition is met or not detects whether the resources provided by the mobile network to the UE is less than what the UE requests within a third period of time when the first priority cell has good signal power. If yes, 6th congestion condition is met in step S706. If no, 6th congestion condition is not met in step S704. In some embodiments, in step S702, the method for determining whether the 6th congestion condition is met or not further detects that the data size of granted upload data of the UE is smaller than that of the BSR multiplying a predetermined percentage within the third period of time when the first priority cell has good signal power.

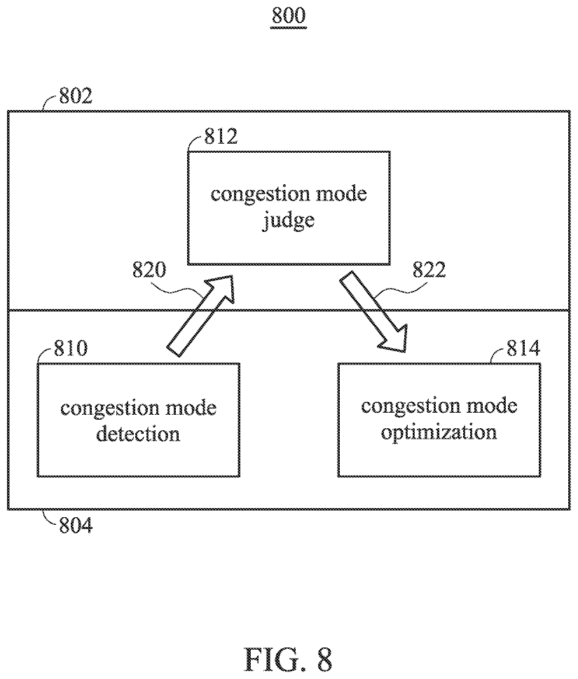

FIG. 8 is a schematic diagram of a user equipment 800 in accordance with some embodiments of the present invention. As shown in FIG. 8, the UE 800 includes an application processor 802 and a modem 804. A block 810 is used for congestion mode detection for the UE 800. In some embodiments, the modem 804 detects six congestion conditions comprising: detecting that the number of access rejections from the mobile network for RRC connection is more than a first threshold within a first period of time (1st congestion condition); detecting that the number of AC barring from the mobile network is more than a second threshold within a second period of time (2nd congestion condition); detecting that the cause value of access rejections from the mobile network for ATTACH/TAU/EMM services is “congestion”, and detecting that a firstback-off timer is present in the access rejections from the mobile network for ATTACH/TAU/EMM services (3rd congestion condition); detecting that the number of consecutive preambles send for success RACH procedure is more than a third threshold when the first priority cell has good signal power (4th congestion condition); detecting that a second back-off timer is present in a RAR message from the mobile network (5th congestion condition); and/or detecting that the resources provided by the mobile network to the UE is less than what the UE requests within a third period of time when the first priority cell has good signal power (6th congestion condition).

In some embodiments, the modem 804 sends a detection result 820 for which congestion condition is/are met to the application processor 802. After receiving the detection result 820 from the modem 804, the application processor 802 implements a block 812 used for congestion mode judgment. In some embodiments, the application processor 802 implements the following tasks: detecting that the UE is in a congestion mode; determining whether the UE enters the RRC connection mode in a first priority cell; determining whether shortening at least one timer of the UE is able to improve the congestion of the mobile network if the UE does not enter the RRC connection mode; and determining whether reporting the larger data size of the BSR to the mobile network is able to improve the congestion of the mobile network if the UE enters the RRC connection mode.

After that, the application processor 802 sends an optimization result 822 to the modem 804 for teaching how to improve the congestion conditions. For example, the optimization result 822 may record congestion conditions 1, 2 and 5 are met at the same time, may record congestion conditions 3 and 6 are met at the same time, or only one of the six congestion condition is met, the present invention is not limited thereto. In some embodiments, the application processor 802 further determines that the congestion of the mobile network is alleviated if shortening the timer of the UE is able to improve the congestion of the mobile network, and determines that the congestion of the mobile network is alleviated if reporting the larger data size of the BSR to the mobile network is able to improve the congestion of the mobile network.

After receiving the optimization result 822 from the application processor 802, the modem 804 implements a block 814 used for congestion mode optimization. In some embodiments, the modem 804 implements the following tasks: reselecting a second priority cell if shortening the timer of the UE is not able to improve the congestion of the mobile network; and handing over to the second priority cell if reporting the larger data size of the BSR to the mobile network is not able to improve the congestion of the mobile network. In some embodiments, the modem 804 further detects that the data size of granted upload data of the UE is smaller than that of the BSR multiplying a predetermined percentage within the third period of time when the first priority cell has good signal power.

Refer to FIGS. 1-8 at the same time, the application processor 802 in FIG. 8 implements steps S100, S102, S104, S106, and S112 in FIG. 1, steps S204 and S206 in FIG. 2, steps S304 and S306 in FIG. 3, steps S406 and S408 in FIG. 4, steps S504 and S506 in FIG. 5, steps S604 and S606 in FIG. 6, and steps S704 and S706 in FIG. 7. In addition, the modem 804 implements steps S108 and S110 in FIG. 1, steps S200 and S202 in FIG. 2, steps S300 and S302 in FIG. 3, steps S400, S402 and S404 in FIG. 4, steps S500 and S502 in FIG. 5, steps S600 and S602 in FIG. 6, and steps S700 and S702 in FIG. 7.

In the several embodiments provided by the present invention, it should be understood that the disclosed system, device, and method can be implemented using other methods. The device embodiments described above are merely illustrative, for example, the division of units is only a logical function division, and there may be other divisions in actual implementation. For example, multiple units or elements can be combined or integrated into another system, or some features may be omitted or not implemented. In addition, the displayed or discussed mutual coupling or direct coupling or communicative connecting may be indirect coupling or communicatively connecting through some interfaces, device or units, and may be in electrical, mechanical, or other forms.

In addition, the functional units in the various embodiments of the present invention may be integrated into one processing unit, or each unit may exist alone physically, or two or more units may be integrated into one unit. The above-mentioned integrated unit can be realized either in the form of hardware or in the form of a software functional unit.

Although the present invention is disclosed above in the preferred embodiment, it is not intended to limit the scope of the present invention. Anyone with ordinary knowledge in the relevant technical field can make changes and modifications without departing from the spirit and scope of the present invention. Therefore, the protection scope of the present invention shall be determined by the scope of the claims.

What is claimed is:

1. A method for optimizing congestion of a mobile network, comprising:
detecting that user equipment (UE) is in a congestion mode;
determining whether the UE enters an RRC connection mode in a first priority cell;
determining whether shortening at least one timer of the UE is able to improve the congestion of the mobile network if the UE does not enter the RRC connection mode;
determining whether reporting larger data size of a buffer status report (BSR) to the mobile network is able to improve the congestion of the mobile network if the UE enters the RRC connection mode;
reselecting a second priority cell if shortening the at least one timer of the UE is not able to improve the congestion of the mobile network; and
handing over to the second priority cell if reporting the larger data size of the BSR to the mobile network is not able to improve the congestion of the mobile network.

2. The method as claimed in claim 1, wherein the step of detecting that the UE is in the congestion mode comprises:
detecting that the number of access rejections from the mobile network for RRC connection is more than a first threshold within a first period of time;
detecting that the number of access class (AC) barring from the mobile network is more than a second threshold within a second period of time;
detecting that the number of consecutive preambles sent for success random-access channel (RACH) procedure is more than a third threshold when the first priority cell has good signal power;
detecting that a first back-off timer is present in a random access response (RAR) message from the mobile network; and/or
detecting that resources provided by the mobile network to the UE is less than what the UE requests within a third period of time when the first priority cell has good signal power.

3. The method as claimed in claim 2, wherein the step of detecting that the UE is in the congestion mode further comprises:
detecting that the cause value of access rejections from the mobile network for ATTACH/TAU/EMM services is “congestion”; and
detecting that a second back-off timer is present in the access rejections from the mobile network for ATTACH/TAU/EMM services.

4. The method as claimed in claim 3, wherein the first threshold, the second threshold, the third threshold, the first period of time, the second period of time, the third period of time are set in the at least one timer of the UE.

5. The method as claimed in claim 3, wherein the first back-off timer is included in the RAR message and the second back-off timer is included in the ATTACH/TAU/EMM REJECT message.

6. The method as claimed in claim 2, wherein the step of detecting that the resources provided by the mobile network to the UE is less than what the UE requests within the third period of time when the first priority cell has good signal power comprises:
detecting that the data size of granted upload data of the UE is smaller than that of the BSR multiplying a predetermined percentage within the third period of time when the first priority cell has good signal power.

7. The method as claimed in claim 1, further comprising:
determining that the congestion of the mobile network is alleviated if shortening the at least one timer of the UE is able to improve the congestion of the mobile network; and
determining that the congestion of the mobile network is alleviated if reporting the larger data size of the BSR to the mobile network is able to improve the congestion of the mobile network.

8. A user equipment (UE), comprising:
an application processor, configured to implement the following tasks:
detecting that the UE is in a congestion mode;
determining whether the UE enters the RRC connection mode in a first priority cell;
determining whether shortening at least one timer of the UE is able to improve the congestion of the mobile network if the UE does not enter the RRC connection mode; and
determining whether reporting the larger data size of the BSR to the mobile network is able to improve the congestion of the mobile network if the UE enters the RRC connection mode;
a modem, configured to implement the following tasks:
reselecting a second priority cell if shortening the at least one timer of the UE is not able to improve the congestion of the mobile network; and
handing over to the second priority cell if reporting the larger data size of the BSR to the mobile network is not able to improve the congestion of the mobile network.

9. The UE as claimed as claimed in claim 8, wherein the application processor detects that the UE is in the congestion mode according to the following tasks performed by the modem, comprising:
detecting that the number of access rejections from the mobile network for RRC connection is more than a first threshold within a first period of time;
detecting that the number of AC barring from the mobile network is more than a second threshold within a second period of time;
detecting that the number of consecutive preambles send for success RACH procedure is more than a third threshold when the first priority cell has good signal power;
detecting that a first back-off timer is present in a RAR message from the mobile network; and/or
detecting that the resources provided by the mobile network to the UE is less than what the UE requests within a third period of time when the first priority cell has good signal power.

10. The UE as claimed as claimed in claim 9, wherein the application processor detects that the UE is in the congestion mode according to the following tasks performed by the modem, further comprising:
detecting that the cause value of access rejections from the mobile network for ATTACH/TAU/EMM services is “congestion”; and
detecting that a second back-off timer is present in the access rejections from the mobile network for ATTACH/TAU/EMM services.

11. The UE as claimed in claim 10, wherein the first threshold, the second threshold, the third threshold, the first period of time, the second period of time, the third period of time are set in the at least one timer of the UE.

12. The UE as claimed in claim 10, wherein the first back-off timer is included in the RAR message and the second back-off timer is included in the ATTACH/TAU/EMM REJECT message.

13. The UE as claimed in claim 9, wherein the modem detects that the resources provided by the mobile network to the UE is less than what the UE requests within the third period of time when the first priority cell has good signal power, comprising:
the modem detects that the data size of granted upload data of the UE is smaller than that of the BSR multiplied by a predetermined percentage within the third period of time when the first priority cell has good signal power.

14. The UE as claimed in claim 8, wherein the application processor further implements the following tasks:
determining that the congestion of the mobile network is alleviated if shortening the at least one timer of the UE is able to improve the congestion of the mobile network; and
determining that the congestion of the mobile network is alleviated if reporting the larger data size of the BSR to the mobile network is able to improve the congestion of the mobile network.
